(19) United States
(12) Patent Application Publication
(10) Pub. No.: US 2023/0063004 A1
(43) Pub. Date: Mar. 2, 2023

(54) SYSTEM AND METHOD FOR CONTROL OF HEAVY MACHINERY

(71) Applicant: DANFOSS A/S, NORDBORG (DK)

(72) Inventors: Joshua Harvey, Cambridge, MA (US); Zhekang Du, Ames, IA (US)

(21) Appl. No.: 17/795,590

(22) PCT Filed: Feb. 15, 2021
(86) PCT No.: PCT/US2021/018104

§ 371 Date: Jul. 27, 2022

Related U.S. Application Data
(60) Provisional application No. 62/986,851, filed on Mar. 9, 2020.

(51) Int. Cl. G05D 1/02; G05D 1/00

(52) U.S. Cl. CPC G05D 1/0223; G05D 1/0094; G05D 2201/0202

(57) ABSTRACT

A system of this disclosure includes an artificial intelligence module, which may include a neural network or a decision tree architecture, configured to analyze data indicative of the manner in which an operator performs tasks using a heavy machine. The artificial intelligence module is further configured to provide instructions pertaining to the control of at least some components of the heavy machine. As such, the heavy machine is operated in whole or in part based on the direction of the artificial intelligence module, which reduces reliance on a human operator. The artificial intelligence module is highly efficient, and in particular the artificial intelligence module is trained relatively quickly. Further, the artificial intelligence module may be embodied on the heavy machinery itself, as opposed to on a cloud-based system or on a more high-powered computer. Accordingly, the cost of implementing and operating the disclosed system is relatively low.

### RELATED APPLICATION(S)

This application claims the benefit of U.S. Provisional Application No. 62/986,851, filed Mar. 9, 2020, the entirety of which is incorporated by reference.

### TECHNICAL FIELD

This disclosure relates to a system and method for controlling heavy machinery.

### BACKGROUND

Heavy machinery refers to heavy-duty vehicles specially designed for executing construction tasks, such as earthwork operations or other construction tasks. Heavy machinery includes backhoe loaders, front loaders, bulldozers, etc. Heavy machinery is typically operated by a skilled operator that is not only trained to drive such large vehicles but is also trained to maneuver the work tool(s) on the heavy machinery.

### SUMMARY

A method according to an exemplary aspect of the present disclosure includes, among other things, collecting data indicative of the manner in which an operator performs tasks using a heavy machine, analyzing the data with an artificial intelligence module, and controlling at least some components of the heavy machine in response to instructions from the artificial intelligence module to perform at least some tasks of the heavy machine.

In a further embodiment, the artificial intelligence module is not cloud based and exists on a controller of the heavy machine.

In a further embodiment, the artificial intelligence module includes a neural network.

In a further embodiment, the artificial intelligence module includes a first layer configured to receive the data, a second long-short term memory layer, a third long short-term memory layer, and a fourth layer configured to generate an output, and the instructions from the artificial intelligence module are based on the output of the fourth layer.

In a further embodiment, the artificial intelligence module is configured to randomly ignore certain pieces of the data.

In a further embodiment, the method includes predicting, based on the data, a task that should be performed.

In a further embodiment, the method includes predicting, based on the data, a time when the predicted task should be performed.

In a further embodiment, the controlling step includes performing the predicted task at the predicted time.

In a further embodiment, the controlling step includes maneuvering a tool of the heavy machine and does not include driving the heavy machine.

In a further embodiment, the controlling step includes limiting engine rotation such that a speed of the engine does not exceed a threshold, and the threshold is determined in the analyzing step.

A heavy machine according to an exemplary aspect of the present disclosure includes, among other things, a controller including an artificial intelligence module. The controller is configured to receive data from at least one component of the heavy machine indicative of the manner in which an operator performs tasks of the heavy machine. The data is configured to be analyzed by the artificial intelligence module. Further, the artificial intelligence module is configured to cause the controller to issue instructions to at least some components of the heavy machine to perform at least some tasks of the heavy machine.

In a further embodiment, the artificial intelligence module is configured to randomly ignore certain pieces of the data.

In a further embodiment, the artificial intelligence module includes a first layer configured to receive the data, a second long-short term memory layer, a third long short-term memory layer, and a fourth layer configured to generate an output.

In a further embodiment, the artificial intelligence module is not cloud based and exists on a controller of the heavy machine.

In a further embodiment, the heavy machine includes a push button configured to cause the artificial intelligence module to perform a learned function.

In a further embodiment, the artificial intelligence module includes a neural network.

In a further embodiment, the heavy machine includes a tool, and the controller is configured to issue instructions to maneuver the tool but is not configured to issue instructions to drive the heavy machine.

### BRIEF DESCRIPTION OF THE DRAWINGS

FIG. 1 schematically illustrates an example system.

FIG. 2 schematically illustrates an example artificial intelligence module.

### DETAILED DESCRIPTION

Again, this disclosure relates to a system and method for controlling heavy machinery. In particular, the system includes an artificial intelligence module, which may include a neural network or a decision tree architecture, configured to analyze data indicative of the manner in which an operator performs tasks using a heavy machine. The artificial intelligence module is further configured to provide instructions pertaining to the control of at least some components of the heavy machine. As such, the heavy machine is operated in whole or in part based on the direction of the artificial intelligence module, which reduces reliance on a human operator. The artificial intelligence module is highly efficient, and in particular the artificial intelligence module is trained relatively quickly. Further, the artificial intelligence module may be embodied on the heavy machinery itself, as opposed to on a cloud-based system or on a more high-powered computer. Accordingly, the cost of implementing and operating the disclosed system is relatively low. These and other benefits will be appreciated from the below written description.

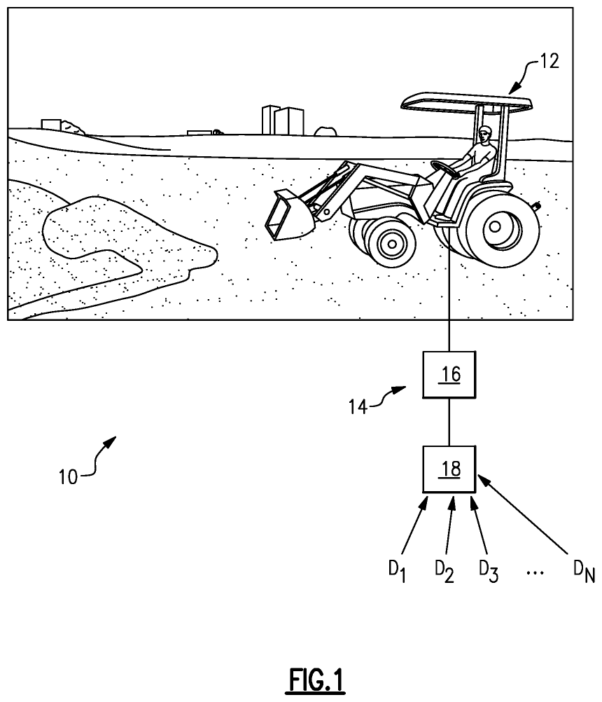

FIG. 1 schematically illustrates a heavy machine system 10 (“system 10”). In this example, the system 10 includes a heavy machine 12, which here is a loader (i.e., a front loader). The heavy machine 12 is a vehicle including wheels driven by a drivetrain, and at least one tool which is maneuverable by one or more actuators. The heavy machine 12 includes various inputs, such as wheels and/or joysticks, configured to drive the heavy machine 12 and maneuver the tool(s). Here, the tool is a loader configured to lift, move, and/or load materials such as dirt, asphalt, snow, debris, etc. While a loader is shown in FIG. 1, this disclosure extends to other types of heavy machines, and also extends to other types of tools.

The components of the system 10 are electrically connected together and are configured to send and receive information relative to one another. The system 10 further includes a computing system 14. The computing system 14 is shown schematically in FIG. 1 and is representative of a combination of hardware devices, software programs, processors, memory, etc. The computer system 14 may be embodied as a single device or a combination of devices.

In this example, the computing system 14 includes a controller 16 which is located on the heavy machine 12. The controller 16 either includes, or is in electric communication with, an artificial intelligence module 18. The term module is used herein to refer to a portion of the computing system 14. The artificial intelligence module 18 may include a combination of hardware and software. Specifically, the artificial intelligence module 18 may be embodied on the controller 16, on a common computer with the controller 16, or on a remote computer, such as a remote server, in electric communication with the controller 16. The controller 16 may include hardware and/or software, and may be programmed with executable instructions for interfacing with and operating the various components of the heavy machine 12, including the tool(s). It should be understood that the controller 16 could be part of an overall control module. The controller 16 includes a processing unit and non-transitory memory for executing the various control strategies and modes of the heavy machine 12.

During operation of the heavy machine 12, an operator (i.e., driver or user) of the heavy machine 12 may drive the heavy machine and/or maneuver the tool of the heavy machine 12 to perform one or more tasks on a jobsite. During such times, the computer system 14 receives a plurality of pieces of data D₁-D_{N}, where “N” represents any number. The data may come from various load and/or position sensors on the heavy machine 12, from the controller 16, from the drivetrain of the heavy machine 12, or from the actuators associated with the tool(s). The data is indicative of the manner in which an operator performs tasks using the heavy machine 12.

In this disclosure, the data is analyzed using the artificial intelligence module 18. Based on the data, the artificial intelligence module 18 issues one or more instructions to the controller 16, or to the various components of the heavy machine 12 directly, to control at least some components of the heavy machine 12. Specifically, the instructions may include instructions to drive the heavy machine 12 at a particular speed and/or in a particular direction, and/or the instructions may include instructions to maneuver the tool(s) of the heavy machine 12 in a particular manner. In this regard, the computing system 14 is in electric communication with the drivetrain of the heavy machine 12 and with various actuators configured to maneuver the tool(s). The instructions cause the heavy machine 12 to perform, at least partially, one or more tasks that the operator would have otherwise fully performed. The artificial intelligence module 18 is also configured to predict which tasks should be performed, at what time, and in what order, by the heavy machine 12. The artificial intelligence module 18 makes such predictions based on the data.

In an aspect of this disclosure, the artificial intelligence module 18 is not configured to issue instructions to drive the heavy machine 12, but is rather limited to predicting future maneuvers of the tool(s) and to issue instructions to maneuver the tool(s) in a particular manner. In this way, the operator of the heavy machine 12 can focus on driving the heavy machine 12 and does not need to divide his or her attention between driving the heavy machine 12 and operating the tool(s).

In a further aspect of this disclosure, the once the artificial intelligence module 18 has learned a particular function, that function may be accessed by the operator as a “push button” function. In other words, the operator may be able to selectively call upon the artificial intelligence module 18 to handle performance of the particular learned function. For instance, if the artificial intelligence module 18 learns how to scoop a pile of dirt, the operator may drive the heavy machine 12 to the pile of dirt and simply press a corresponding button (i.e., a physical button, a button embodied on a touchscreen, or some other input) and the heavy machine 12 will scoop the pile dirt. In another aspect of this disclosure, the artificial intelligence module 18 predicts when the dirt should be scooped and either prompts the operator, asking whether the operator would like to initiate the action, or simply initiates the action itself when the artificial intelligence module 18 determines it is appropriate to do so.

In one particular aspect of the disclosure, the artificial intelligence module 18 learns, over time, that the operator seeks to limit the rate at which an engine of the heavy machine 12 is rotating, which may be measured in revolutions per minute (RPM). In an example, the artificial intelligence module 18 may observe from the data that the operator typically seeks to keep the RPM of the engine under a threshold value, such as 6,500 RPM. The operator may from time to time exceed that value while performing certain tasks, and the artificial intelligence module 18 may observe from the data that the operator typically manually takes corrective action when that value is exceeded. Once the artificial intelligence module 18 learns that the operator is seeking to limit engine RPM, the artificial intelligence module 18 may begin to do so on its own. Alternatively, the operator may activate this aspect of the artificial intelligence module 18 using a “push button” as discussed above, and/or the artificial intelligence module 18 may prompt the operator, asking if the operator wishes to have the computing system 14 regulate engine RPM during a particular task. Additionally, the artificial intelligence module 18 may perform certain jobsite tasks in a particular order or in a particular manner to optimize engine RPM, if the artificial intelligence module 18 determines that keeping engine RPM below a particular threshold is a desirable objective. The artificial intelligence module 18 may override this objective if speed regardless of engine RPM, for instance, becomes more desirable. In another aspect of this disclosure, the artificial intelligence module 18 may learn to prevent the engine from stalling.

In another example, the artificial intelligence module 18 is configured to issue instructions to drive the heavy machine 12, and is not configured to issue instructions to maneuver the tool(s). In this example, as with the earlier-mentioned example, the attention of the operator does not need to be divided between functions. In yet another example, the artificial intelligence module 18 is configured to issue instructions configured to drive the heavy machine 12 and maneuver the tool(s). In this example, and any others, the operator may still be present in the heavy machine 12 and may observe the operation of the heavy machine 12 and intervene, if the operator deems it necessary. In any of these examples, the mental load on the operator is reduced.

The artificial intelligence module 18 of this disclosure operates relatively efficiently and is capable of being trained in a relatively short period of time. In particular, the artificial intelligence module 18 may train itself to perform a certain jobsite task by observing (i.e., receiving and analyzing the data associated with the heavy machine 12 during) about 10 to 15 iterations of such a task. This is contrasted with traditional artificial intelligence which may take about 100 iterations to train an artificial intelligence module to perform a task.

One aspect of this disclosure that leads to increased efficiency of the artificial intelligence module 18 is that the artificial intelligence module 18 randomly ignores certain pieces of the data. By randomly ignoring certain pieces of data, the artificial intelligence module 18 more efficiently determines the importance of a particular piece of data. Because the artificial intelligence module 18 is so efficient, it is not necessary to embody the artificial intelligence module 18 on a large computer, such as a server or a separate, high-powered computer on the heavy machine 12. Rather, the artificial intelligence module 18 can run on an existing, relatively low-powered computer, such as those that are already part of most traditional heavy machines.

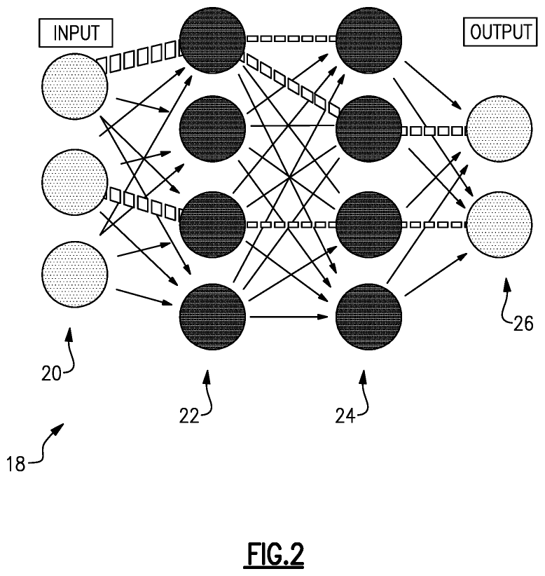

FIG. 2 is a schematic illustrating additional detail of an example artificial intelligence module 18. In FIG. 2, the example artificial intelligence module 18 includes a first layer 20 configured to receive the data D₁-D_{N}, a second long short-term memory (LSTM) layer 22, a third LSTM layer 24, and a fourth layer 26 configured to generate an output, which is delivered either to the controller 16 or directly to one or more of the components of the heavy machine 12. The term layer is used herein to refer to the collection of nodes operating together at a specific depth within the artificial intelligence module 18. The second and third LSTM layers 24, 26 may be hidden layers in one example. Other example artificial intelligence module architectures come within the scope of this disclosure. That said, by using the architecture of FIG. 2 combined with randomly ignoring certain pieces of data, the artificial intelligence module 18 is relatively efficient and can run on a low-powered computer.

The artificial intelligence module 18 may include or be a neural network. The neural network may be a deep generative neural network, which is alternatively referred to as a flow model neural network. The neural network, if present, provides a framework for machine learning. Specifically, the neural network is trained to predict how various data inputs (i.e., from the data D₁-D_{N}) relate to a particular jobsite task, including training the neural network to perform (i.e., learn the instructions to cause the heavy machine 12 to perform) those tasks and/or to predict when the task needs to be performed. While a neural network is mentioned, the artificial intelligence module 18 is not limited to a neural network. Rather, the artificial intelligence module 18 may include another architecture such as a decision tree architecture.

The artificial intelligence module 18 may be continually trained as the heavy machine 12 is used. In other words, training does not stop after the initial training. Thus, over time, the artificial intelligence module 18 becomes better at performing certain jobsite functions and makes more accurate predictions. In fact, the beauty of this disclosure is that it is not possible to predict all the ways the artificial intelligence module 18 may react to certain combinations of data. That is, as the artificial intelligence module 18 continues its machine learning process, the artificial intelligence module 18 may take actions or make predictions that are not possible to predict today but are ultimately beneficial.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A method, comprising:
collecting data indicative of the manner in which an operator performs tasks using a heavy machine;
analyzing the data with an artificial intelligence module; and
controlling at least some components of the heavy machine in response to instructions from the artificial intelligence module to perform at least some tasks of the heavy machine.

2. The method as recited in claim 1, wherein the artificial intelligence module is not cloud based and exists on a controller of the heavy machine.

3. The method as recited in claim 1, wherein the artificial intelligence module includes a neural network.

4. The method as recited in claim 1, wherein:
the artificial intelligence module includes a first layer configured to receive the data, a second long-short term memory layer, a third long short-term memory layer, and a fourth layer configured to generate an output, and
the instructions from the artificial intelligence module are based on the output of the fourth layer.

5. The method as recited in claim 4, wherein the artificial intelligence module is configured to randomly ignore certain pieces of the data.

6. The method as recited in claim 1, further comprising:
predicting, based on the data, a task that should be performed.

7. The method as recited in claim 6, further comprising:
predicting, based on the data, a time when the predicted task should be performed.

8. The method as recited in claim 7, wherein the controlling step includes performing the predicted task at the predicted time.

9. The method as recited in claim 1, wherein the controlling step includes maneuvering a tool of the heavy machine and does not include driving the heavy machine.

10. The method as recited in claim 1, wherein:
the controlling step includes limiting engine rotation such that a speed of the engine does not exceed a threshold, and
the threshold is determined in the analyzing step.

11. A heavy machine, comprising:
a controller including an artificial intelligence module, wherein the controller is configured to receive data from at least one component of the heavy machine indicative of the manner in which an operator performs tasks of the heavy machine, wherein the data is configured to be analyzed by the artificial intelligence module, and wherein the artificial intelligence module is configured to cause the controller to issue instructions to at least some components of the heavy machine to perform at least some tasks of the heavy machine.

12. The heavy machine as recited in claim 11, wherein the artificial intelligence module is configured to randomly ignore certain pieces of the data.

13. The heavy machine as recited in claim 12, wherein the artificial intelligence module includes a first layer configured to receive the data, a second long-short term memory layer, a third long short-term memory layer, and a fourth layer configured to generate an output.

14. The heavy machine as recited in claim 13, wherein the artificial intelligence module is not cloud based and exists on a controller of the heavy machine.

15. The heavy machine as recited in claim 11, further comprising:
a push button configured to cause the artificial intelligence module to perform a learned function.

16. The heavy machine as recited in claim 11, wherein the artificial intelligence module includes a neural network.

17. The heaving machine as recited in claim 11, further comprising a tool, and wherein the controller is configured to issue instructions to maneuver the tool but is not configured to issue instructions to drive the heavy machine.
